(19) United States
(12) Patent Application Publication
(10) Pub. No.: US 2013/0227311 A1
(43) Pub. Date: Aug. 29, 2013

(54) POWER SUPPLY DEVICE FOR COMPUTER SYSTEMS

(71) Applicants: BO TIAN, Shenzhen City (CN); GUO-YI CHEN, Shenzhen City (CN)

(72) Inventors: BO TIAN, Shenzhen City (CN); GUO-YI CHEN, Shenzhen City (CN)

(21) Appl. No.: 13/648,260

(22) Filed: Oct. 9, 2012

(30) Foreign Application Priority Data
Feb. 29, 2012 (CN) 201210049007.3

(51) Int. Cl. G06F 1/26

(52) U.S. Cl. 713/300

(57) ABSTRACT

A power supply device for a computer system with a plurality of servers includes a control unit, a main board, and a connection unit. The control unit includes a plurality of switches. The main board includes a power supply and a strobe circuit. When any one or more of the switches is turned on, each turned-on switch generates a control signal. The control signal causes the power supply to be turned on, and simultaneously causes the strobe circuit to generate a selection signal corresponding to the turned-on switch. The connection unit electrically connects the power supply to a server corresponding to the turned-on switch in response to reception of the selection signal from the strobe circuit by the connection unit.

### BACKGROUND

1. Technical Field

The present disclosure relates to power supply devices, and particularly to a power supply device for computer systems with a plurality of servers.

2. Description of Related Art

A computer system can employ a plurality of servers to enhance data processing capability. For example, a common four-in-one server system includes four servers, and the four servers share one hard disk backboard to be electrically connected to hard disk drives. In use, each of the four servers can control a plurality of hard disk drives via the hard disk backboard, so that the four-in-one server system achieves high data processing capability.

In a computer system employing a plurality of servers, the servers generally require to be capable of working independently from each other to prevent failures of any one of the servers from adversely affecting the other servers. Therefore, each of the servers may need a power supply that is independent from power supplies of the other servers. However, equipping an exclusive power supply for each of the servers may be costly and complicate a hardware structure of the computer system.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of a power supply device, according to an exemplary embodiment.

FIG. 2 is a circuit diagram of the power supply device shown in FIG. 1.

### DETAILED DESCRIPTION

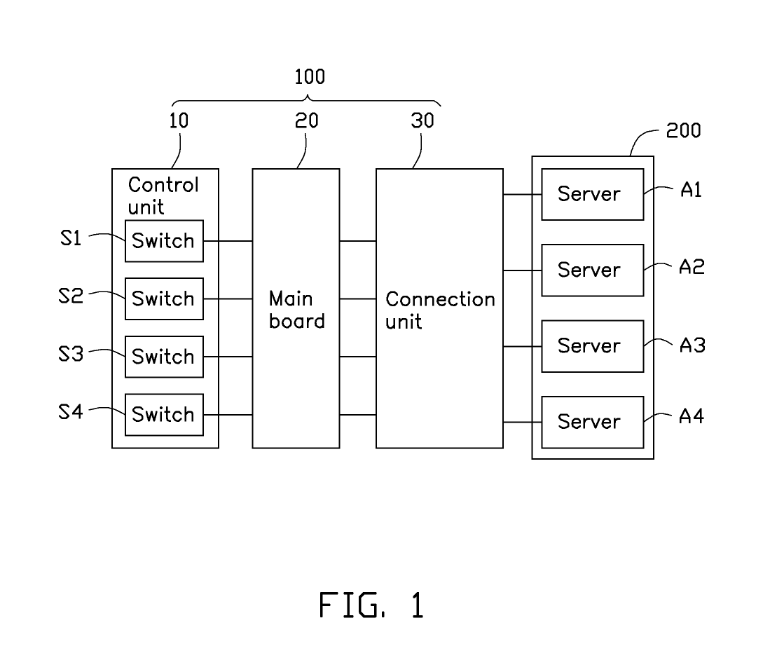

FIG. 1 is a block diagram of a power supply device 100, according to an exemplary embodiment. The power supply device 100 is configured to provide electrical power to computer systems with a plurality of servers. In this embodiment, the power supply device 100 is utilized to provide electrical power to a computer system 200, which is a four-in-one computer system. The computer system 200 includes four servers A1, A2, A3, and A4. The power supply device 100 can selectively provide electrical power to any one or more of the four servers A1-A4.

The power supply device 100 includes a control unit 10, a main board 20, and a connection unit 30. The control unit 10, the main board 20, and the connection unit 30 are electrically connected in series. The four servers A1-A4 are all electrically connected to the connection unit. The control unit 10 can be a control panel, and includes four switches S1, S2, S3, and S4 corresponding to the four servers A1-A4. Operations applied to each of the switches S1-S4 can control the main board 20 to provide electrical power to a corresponding one of the servers A1-A4 via the connection unit 30. In this embodiment, each of the switches S1-S4 generates a predetermined logic 0 signal (e.g., a relatively lower voltage) when it is turned on, and generates a predetermined logic 1 signal (e.g., a relatively higher voltage) when it is turned off.

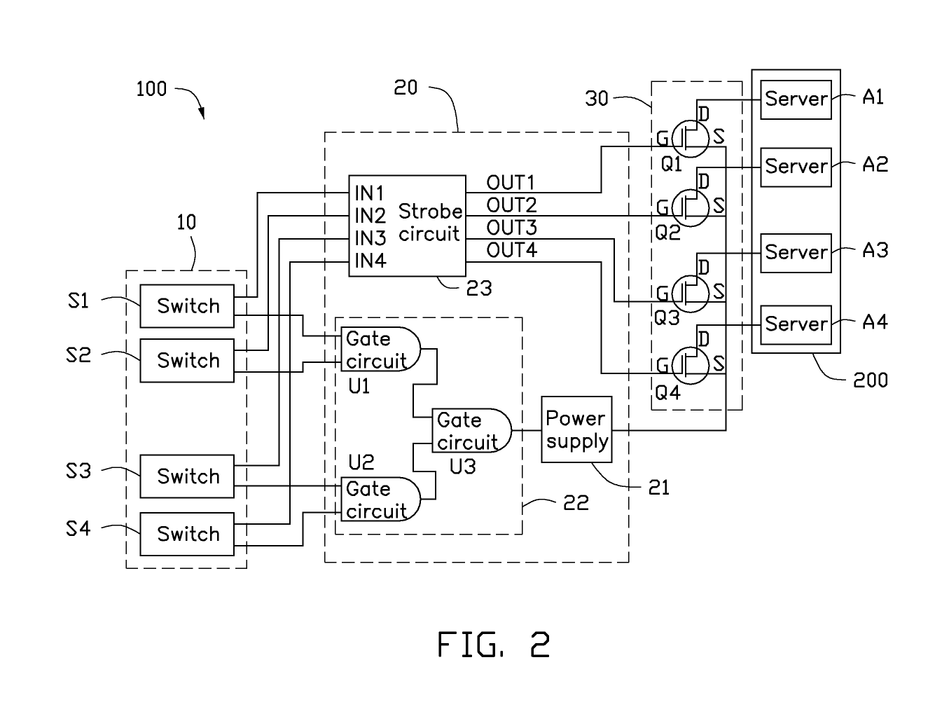

Also referring to FIG. 2, the main board 20 includes a power supply 21, a logic circuit 22, and a strobe circuit 23. The power supply 21 can be a battery, or an electrical connector configured for electrically connecting with a wall socket. The logic circuit 22 includes three gate circuits U1, U2, and U3. In this embodiment, the three gate circuits U1, U2, and U3 are all AND gates. The switches S1 and S2 are respectively electrically connected to two input ends of the gate circuit U1, the switches S3 and S4 are respectively electrically connected to two input ends of the gate circuit U2, and output ends of the gate circuits U1 and U2 are respectively electrically connected to two input ends of the gate circuit U3. An output end of the gate circuit U3 is electrically connected to the power supply 21 to switch on and off the power supply 21. In this embodiment, a predetermined logic 0 signal (e.g., a relatively lower voltage) output by the gate circuit U3 is used to turn on the power supply 21, and a predetermined logic 1 signal (e.g., a relatively higher voltage) output by the gate circuit U3 is used to turn off the power supply 21.

The strobe circuit 23 can be an integrated circuit (IC) in a type of IDTQS3125QG8. The strobe circuit 23 includes four input pins N1, IN2, IN3, and IN4 corresponding to the four switches S1-S4, and four output pins OUT1, OUT2, OUT3, and OUT4 corresponding to the four input pins IN1-IN4. The four switches S1-S4 are respectively electrically connected to the four input pins IN1-IN4. When any one of the switches S1-S4 is turned on, the logic 0 signal generated by the turned on switch S1/S2/S3/S4 is input to the strobe circuit 23 via the input pin IN1/IN2/IN3/IN4 corresponding to the turned on switch S1/S2/S3/S4, and controls the strobe circuit 23 generates a selection signal on the output pin OUT1/OUT2/OUT3/OUT4 corresponding to the input pin IN1/IN2/IN3/IN4 receiving the logic 0 signal.

The connection unit 30 includes four transistors Q1, Q2, Q3, and Q4 corresponding to the four switches S1-S4. Each of the four transistors Q1-Q4 is a metal-oxide-semiconductor field-effect transistor (MOSFET), and includes a gate G, a drain D, and a source S. The gates G of the transistors Q1-Q4 are respectively electrically connected to the output pins OUT1-OUT4 of the strobe circuit 23, the drains D of the transistors Q1-Q4 are respectively electrically connected to the servers A1-A4, and the sources S of the transistors Q1-Q4 are all electrically connected to the power supply 21. When the gate G of any of the transistors Q1-Q4 receives an aforementioned selection signal from the corresponding output pin OUT1/OUT2/OUT3/OUT4, the transistor Q1/Q2/Q3/Q4 receiving the selection signal is turned on, and the drain D and the source S of the transistor Q1/Q2/Q3/Q4 are electrically connected with each other.

When the switches S1-S4 are all turned off, all input ends of the gate circuits U1 and U2 receive logic 1 signals. Thus, the gate circuits U1 and U2 output logic 1 signals to the two input ends of the gate circuit U3, and the gate circuit U3 outputs a logic 1 signal to the power supply 21 to keep the power supply 21 from being turned off.

In use, if any one or more of the four servers A1-A4 requires power, one or more of the switches S1-S4 corresponding to the server A1/A2/A3/A4 requiring power is turned on. The turned on switch S1/S2/S3/S4 inputs the aforementioned logic 0 signal to the input end of the corresponding gate circuit U1 and/or U2. Thus, the gate circuit U1 and/or U2 outputs a logic 0 signal, and causes the gate circuit U3 to output a logic 0 signal to the power supply 21. Upon receiving the logic 0 signal from the gate circuit U3, the power supply 21 is turned on.

At the same time, the logic 0 signal generated by the turned on switch S1/S2/S3/S4 is also input to the strobe circuit 23 via the input pin IN1/IN2/IN3/IN4 corresponding to the turned on switch S1/S2/S3/S4. Thus, the strobe circuit 23 generates a selection signal on the output pin OUT1/OUT2/OUT3/OUT4 corresponding to the input pin IN1/IN2/IN3/IN4 receiving the logic 0 signal from the turned on switch S1/S2/S3/S4. The selection signal is transmitted to the gate G of the transistor Q1/Q2/Q3/Q4 corresponding to the turned on switch S1/S2/S3/S4 and turns on the transistor Q1/Q2/Q3/Q4. In this way, the turned on power supply 21 is electrically connected to the server A1/A2/A3/A4 requiring power via the source S and the drain D of the transistor Q1/Q2/Q3/Q4, and provides electrical power to the server A1/A2/A3/A4.

According to the above-described method, in the power supply device 100, turning on any one or more of the switches S1-S4 can cause the power supply 21 to be turned on. At the same time, only the transistor Q1/Q2/Q3/Q4 corresponding to the turned on switch S1/S2/S3/S4 is turned on, so that only the server A1/A2/A3/A4 corresponding to the turned on switch S1/S2/S3/S4 is electrically connected to the power supply 21 to obtain electrical power. In this way, the power supply device 100 is capable of selectively providing electrical power to any one or more of the servers S1-S4, and power supply of each of the servers S1-S4 is independent from that of the other of the servers S1-S4. By means of using the power supply device 100, the computer system 200 does not need to equip an exclusive power supply for each of the servers S1-S4. Therefore, the computer system 200 is enabled to cost less, and a hardware structure of the computer system 200 is simplified.

In a second embodiment, the gate circuits U1, U2, U3 are all OR gates. Each of the switches S1-S4 generates a predetermined logic 1 signal (e.g., a relatively higher voltage) when it is turned on, and generates a predetermined logic 0 signal (e.g., a relatively lower voltage) when it is turned off. A predetermined logic 1 signal (e.g., a relatively higher voltage) output by the gate circuit U3 is used to turn on the power supply 21, and a predetermined logic 0 signal (e.g., a relatively lower voltage) output by the gate circuit U3 is used to turn off the power supply 21. When any one of the switches S1-S4 is turned on, the logic 1 signal generated by the turned on switch S1/S2/S3/S4 is input to the strobe circuit 23 via the input pin IN1/IN2/IN3/IN4 corresponding to the turned on switch S1/S2/S3/S4, and controls the strobe circuit 23 generates a selection signal on the output pin OUT1/OUT2/OUT3/OUT4 corresponding to the input pin IN1/IN2/IN3/IN4 receiving the logic 1 signal.

In use of the second embodiment, when the switches S1-S4 are all turned off, all input ends of the gate circuits U1 and U2 receive logic 0 signals. Thus, the gate circuits U1 and U2 output logic 0 signals to the two input ends of the gate circuit U3, and the gate circuit U3 outputs a logic 0 signal to the power supply 21 to keep the power supply 21 from being turned off. When any one or more of the switches S1-S4 is turned on, the logic 1 signal generated by the turned on switch S1/S2/S3/S4 can cause the gate circuit U3 to output a logic 1 signal, so that the power supply 21 is turned on. At the same time, the strobe circuit 23 receives the logic 1 signal generated by the turned on switch S1/S2/S3/S4, and transmits the selection signal to the transistor Q1/Q2/Q3/Q4 corresponding to the turned on switch S1/S2/S3/S4 to turn on the transistor Q1/Q2/Q3/Q4, thereby electrically connecting the power supply 21 to the server A1/A2/A3/A4 corresponding to the turned on switch S1/S2/S3/S4 to provide electrical power to the server A1/A2/A3/A4.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply device for a computer system with a plurality of servers, comprising:
a control unit including a plurality of switches corresponding to the servers;
a main board including a power supply and a strobe circuit, each of the switches electrically connected to both the power supply and the strobe circuit; and
a connection unit electrically connected to the power supply, the strobe circuit, and the servers;
wherein when any one or more of the switches is turned on, each turned-on switch generates a control signal; the control signal causes the power supply to be turned on, and simultaneously causes the strobe circuit to generate a selection signal corresponding to the turned-on switch; and the connection unit electrically connects the power supply to the server corresponding to the turned-on switch in response to reception of the selection signal from the strobe circuit by the connection unit.

2. The power supply device of claim 1, wherein the main board further includes a logic circuit electrically connected between the control unit and the power supply; and when any one or more of the switches is turned on, the logic circuit performs a logic operation on the control signal generated by each turned on switch and transmits the a result of the logic operation to the power supply.

3. The power supply device of claim 2, wherein the logic circuit applies an AND operation to the control signals of all turned on switches, and transmits a result of the AND operation to the power supply.

4. The power supply device of claim 2, wherein the logic circuit applies an OR operation to the control signals of all turned on switches, and transmits a result of the OR operation to the power supply.

5. The power supply device of claim 1, wherein the strobe circuit includes a plurality of input pins and output pins corresponding to the switches, the switches are respectively electrically connected to the input pins, and the output pins are all electrically connected to the connection unit; when the control signal generated by each turned-on switch is transmitted to the strobe circuit via the input pin corresponding to the turned-on switch, the strobe circuit generates the selection signal corresponding to the turned-on switch on the output pin corresponding to the input pin receiving the control signal.

6. The power supply device of claim 5, wherein the connection unit includes a plurality of transistors corresponding to the servers, each of the transistors is a metal-oxide-semiconductor field-effect transistor (MOSFET) and includes a gate, a drain, and a source; and the gates of the transistors are respectively electrically connected to the output pins of the strobe circuit, the drains of the transistors are respectively electrically connected to the servers, and the sources of the transistors are all electrically connected to the power supply.

7. The power supply device of claim 6, wherein when the gate of any one or more of the transistors receives the selection signal from the output pin corresponding to the transistor, the transistor is turned on and electrically connects the power supply to the server corresponding to the transistor via the source and the drain of the transistor.
